(19) United States
(12) Patent Application Publication
(10) Pub. No.: US 2007/0206797 A1
(43) Pub. Date: Sep. 6, 2007

(54) SEAMLESS RFID TAG SECURITY SYSTEM

(75) Inventors: Christopher Y. Chan, Erie, CO (US); Vikram M. Shah, Boulder, CO (US); Sayan Chakraborty, Niwot, CO (US)

Correspondence Address: INTELLECTUAL PROPERTY LAW OFFICES, 1901 S. BASCOM AVENUE, SUITE 660, CAMPBELL, CA, 95008, US

(73) Assignee: SKYETEK, INC., Bolder, CO (US)

(21) Appl. No.: 11/307,976

(22) Filed: Mar. 1, 2006

(51) Int. Cl. H04K 1/00

(52) U.S. Cl. 380/270

(57) ABSTRACT

A Radio Frequency Identification (RFID) security system having a client, that includes a computerized system, at least one RFID tag, and a RFID reader. The computerized system and RFID reader employ a first security protocol and the RFID reader and RFID tags employ a second security protocol for communications. The security protocols permit encryption and/or authentication, and use either the same key exchange algorithms, the same encryption algorithms, and/or related keys to provide seamless communications within the RFID security system.

### RELATED APPLICATIONS

This application is a continuation-in-part of U.S. patent application Ser. No. 11/323,214, filed Dec. 30, 2005, the disclosure of which is incorporated herein by reference.

### BACKGROUND ART

FIGS. 1a-b (background art) are schematic block diagrams depicting prior art Radio Frequency Identification systems (RFID systems 10). FIG. 1a shows how an RFID system 10 can initially seem straightforward. At one end is an entity, which we term a client 12 for reasons explained below. At the other end is an RFID tag 14, also frequently called a transponder. The goal then is for the client 12 to communicate with the RFID tag 14. The content of such communications can also seem simple: the client 12 may seek to issue commands to, or provide data to, the RFID tag 14; to receive data from the RFID tag 14; or combinations of these.

Complexity in this starts to be revealed, however, when one looks closer. The client 12 will include a human being or a sophisticated automated system. This means that the client 12 needs to include or itself be a sophisticated computerized system 16. Furthermore, the RFID tag 14 has to be written to and/or read with RF energy. This means that the client 12 also needs to itself be, or be able to work with, a RFID reader 18 (FIG. 1b), also frequently called an interrogator.

In contrast, RFID tags 14 are at the opposite end of a sophistication-complexity spectrum from the client 12. A passive type RFID tag typically includes an integrated circuit and an antenna (and often some material encapsulating these). An active type RFID tag further has a battery, fuel cell, or other power source. While these sub-systems can all entail considerable specialized development, an RFID tag 14 is actually a relatively simple system overall.

Having sophisticated systems and simple systems communicate with one another would seem straightforward, but that is not the case in the RFID field today. This is because there are many different RFID systems available with very little standardization among them. Furthermore, what standardization does exist is largely limited to niches defined by technology types and manufacturers. This is especially the case for RFID systems where communications security, authentication, and audit ability are important.

Taking a rough inventory of actual and potential RFID-related technologies can be helpful. Starting with the client 12, whether a human or an automated system, the client 12 includes the computerized system 16. Many candidates for this exist and, without limitation, some are special microprocessor-based systems, personal computers (PCs, including laptops), personal digital assistants/appliances (PDAs), and even some cellular telephones. Servers and networks may also be employed, on their own or as part of a larger, distributed computerized system 16.

Using a custom microprocessor-based system for the computerized system 16 will usually exacerbate the problems being addressed here. The manufacturers of these often have little incentive to make them work with the products and protocols of other manufacturers, and users often do not want to invest in learning and working with non-standard user interfaces. While historically very significant, the RFID industry today is moving away from dedicated microprocessor-based RFID readers. One part of this trend is to adapt such specialized systems into ones that can communicate with more general computerized system 16, and another part of this trend is to make “dumb” RFID readers that are intended to be used with a general computerized system 16 in the first place.

The preeminent general computerized system 16 today is the PC, and many attributes that are useful in these also often exist in PDAs, cell phones, etc. Rather than being “specialized,” these devices are usually highly “standardized” and many aspects of this are potentially useful for RFID purposes. For instance, such devices tend to use standardized operating systems and programming software, and there are large numbers of talented and experienced programmers for these available. General computerized systems 16 systems also tend to use, or to have easily available, security protocols that are strong, well established, and highly trusted.

Secure sockets layer (SSL) is an example of such a security protocol. It was specifically designed to securely transmit data back and forth across potentially unsecured links. To establish a secure SSL connection, a system needs a SSL certificate consisting of a public key and a private key. When one such system then communicates with another remote one, a SSL handshake authenticates the two systems and permits establishing an encryption method and a unique session key to be used for further communications. The two systems can then engage in a secure session with a strong assurance of the privacy and integrity of the data that they exchange. In passing, transport layer security (TLS) is a derivative of SSL that is particularly suitable for stream-oriented information.

Continuing with general computerized systems 16 and their suitability for use with the clients 12 of the RFID systems 10 of interest here, one thing these computerized system 16 may lack is the ability to directly act as an RFID reader. Many of these devices have some form of RF energy sub-system, such as IEEE 802.11x WiFi, Bluetooth, cellular telephone service adapters, etc., but these sub-systems have not been adapted to function as RFID readers.

FIG. 1b therefore shows a more complete typical RFID system 10 today. The client 12 includes a general computerized system 16 that communicates with an RFID reader 18 via a first link 20, and the RFID reader 18 then communicates with the RFID tag 14 via a second link 22.

The first link 20 can be as simple as a cable connection, which of course means that the computerized system 16 and the RFID reader 18 have to be in very close proximity. The utility of a RFID system 10 employing this scheme is accordingly severely limited. More desirably, the first link 20 should permit communications across a formal network, like the Internet. This capability is very useful, as long as it does not undermine the security of the RFID system 10. Furthermore, of great concern to network administrators today, adding a RFID system 10 should not undermine the security of an organizational network that the RFID system 10 is made part of. Thus, for example, having the first link 20 communicate across the Internet and use a protocol like Telnet is simply not acceptable to many network administrators.

The second link 22 is another matter. It inherently needs to be employ RF communications, and it should minimally increase the cost or complexity of the RFID tags 14 that it is used with. Yet it still also must be secure for many applications. This is the point where non-standardization is encountered in the RFID industry today. Most manufactures use their own proprietary security protocol across the second link 22. Some of these are based on standard algorithms like DES and 3DES/TDEA, but with proprietary usage models. Additionally, the protocols used vary markedly from tag manufacturer to manufacturer. The net result is that RFID tags 14 tend to be tied to specific RFID readers 18, and most present RFID systems 10 are therefore essentially non-standardized from the client 12 onwards. Thus, while the user of a PC in New York can seamlessly, efficiently, and securely communicate with the user of a PDA in London, there presently is no similar ability for a client 12 in a RFID system 10 to communicate seamlessly, efficiently, and securely with remote RFID tags 14.

### SUMMARY

Briefly, in an embodiment, a Radio Frequency Identification (RFID) security system includes a client having a computerized system, at least one RFID tag, and a RFID reader. The computerized system and RFID reader employ a first security protocol, and the RFID reader and RFID tag(s) employ a second security protocol to communicate. The first and second security protocols permit at least one of encryption and authentication, thus providing security for communications within the RFID security system. The first and second security protocol also both use at least one of the same key exchange algorithms, the same encryption algorithms, and related keys, thus providing seamless communications within the RFID security system.

Briefly, in an embodiment, a method for providing secured communications in a Radio Frequency Identification (RFID) system includes securing communications between a client having a computerized system and at least one RFID tag, wherein the communications pass via a RFID reader. A network link employing a first security protocol is established between the computerized system and the RFID reader. A radio frequency (RF) link employing a second security protocol is established between the RFID reader and the RFID tag. The RF link employs a second security protocol in which at least one of the same key exchange algorithms, the same encryption algorithms, and related keys are also used by the first security protocol. At least one command for the RFID tag from the computerized system, instance of data for the RFID tag from the computerized system, or instance of data for the computerized system from the RFID tag is then communicated between the computerized system and the RFID tag(s).

### BRIEF DESCRIPTION OF THE DRAWINGS

FIGS. 1a-b (prior art) are schematic block diagrams depicting current RFID systems, wherein FIG. 1a shows one simple RFID system, and FIG. 1b shows a more complete typical RFID system.

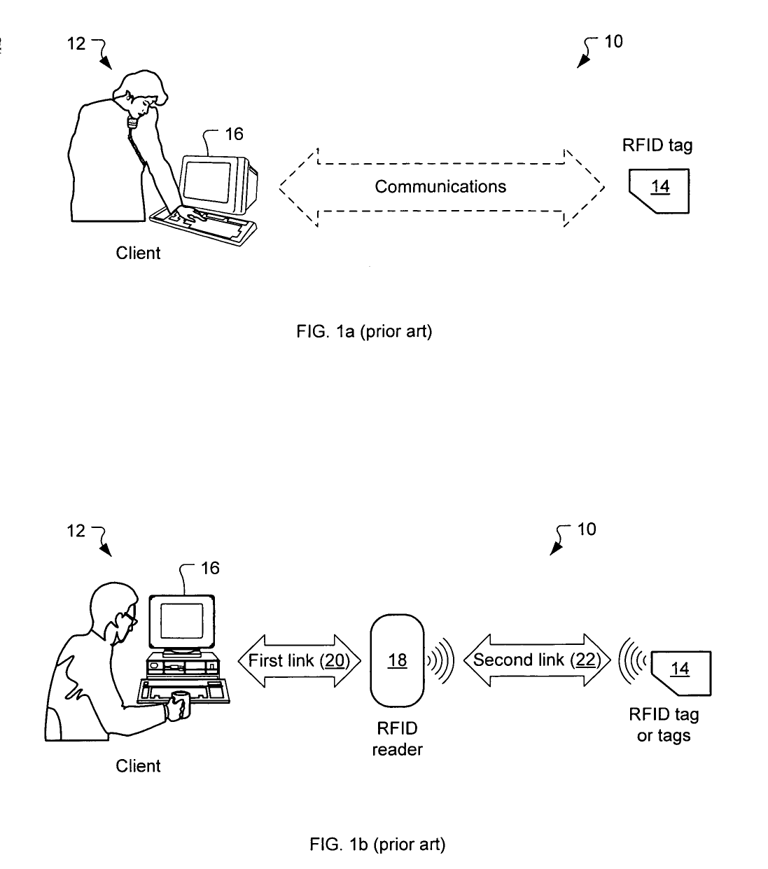

FIG. 2 is a schematic diagram stylistically depicting an embodiment of a RFID tag security system, according to an embodiment.

FIG. 3 is a schematic diagram depicting how seamless communications between the client and the RFID tags in the RFID tag security system of FIG. 2 can follow two basic scenarios providing either a literal or a simulated session, according to an embodiment.

FIGS. 4a-c are schematic block diagrams depicting some example mechanisms for using auditable secure protocols, according to an embodiment.

In the various figures, like references are used to denote like or similar elements or steps.

### DETAILED DESCRIPTION

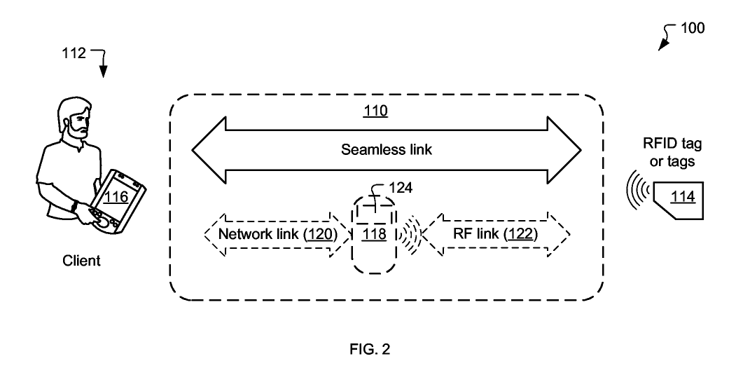

FIG. 2 is a schematic diagram stylistically depicting RFID tag security system 100. Here a seamless link 110 permits a client 112 to communicate with one or more RFID tags 114. This communication is desirably secure. Additionally, in many embodiments this communication is auditable, and the client 112 and the RFID tags 114 can be authenticated.

The client 112 includes a computerized system 116 but, unlike the general prior art, this is not a custom microprocessor-based system purpose-built and dedicated to RFID use. Rather, the computerized system 116 is a conventional PC or laptop computer or similar device and, to emphasize the scope of devices that may serve here, FIG. 2 shows a PDA being used.

The seamless link 110 permits simulated, end-to-end communications sessions between the computerized system 116 of the client 112 and the RFID tags 114. The seamless link 110 includes a RFID reader 118, a network link 120, and a RF link 122. Sub-elements within RFID system 10 and seamless link 110 can differ, and the manner of their use is quite different.

The RFID reader 118 shown in FIG. 2 includes a SSL enablement 124 enabling RFID reader 118 to engage in SSL/TSL sessions with the computerized system 116 across the network link 120. The Secure Sockets Layer (SSL) protocol was briefly described above. The following summarizes it in more detail and is based on “Description of the Secure Sockets Layer (SSL) Handshake,” Article ID: 257591, Jun. 23, 2005 by Microsoft Corporation.

The SSL protocol uses a combination of asymmetric cryptography (public-key), permitting easier authentication, and symmetric cryptography, permitting faster processing. An SSL session begins with an exchange of messages called a SSL handshake.

1. A first system, often termed the “client,” sends a first message (M1) to a second system, often termed a “server.” [Terming a RFID reader 118 a server may conflict with the general public's perception of a server always being the more powerful device, but herein the term is employed as used by professionals skilled in this art.] M1 includes information that the server will need for SSL communications with the client. Specifically, M1 includes the client's SSL version number, cipher settings, session-specific data, and any other information the client deems it desirable for the server to have. Optionally, M1 may include a request for one or more resources for which the server will require client authentication (and the following description presumes this to be the case).

2. The server then sends a second message (M2) to the client, including information that the client will need for SSL communications with the server. Specifically, M2 includes the server's SSL version number, SSL certificate, cipher settings, session-specific data, and any other information the server deems it desirable for the client to have. M2 also includes a request for the client's SSL certificate.

3. Upon receipt of M2, the client uses the information in it to authenticate the server.

4. The client now sends a third message (M3) to the server. M3 includes an encrypted pre-master secret, a signed piece of data, and the client's certificate. The client selects the pre-master secret, and it encrypts this using the server's public key. The piece of data is unique to this handshake and known by both it and the server, and the client signs this. The client now has a master secret or can generate it from the pre-master secret, for use at its end to generate a symmetric session key to encrypt and decrypt the information exchanged during the SSL session, and to verify its integrity.

5. Upon receipt of the M3, the server authenticates the client, uses its private key to decrypt the pre-master secret, and generates the master secret for use at its end to encrypt, decrypt, and verify exchanged information during the SSL session.

6. The client sends a fourth message (M4) to the server, informing it that future client messages will be encrypted with the session key. It also then sends a separate (encrypted) fifth message (M5) indicating that its portion of the handshake is finished.

7. The server sends a sixth message (M6) to the client, informing it that future server messages will be encrypted with the session key. It then also sends a separate (encrypted) seventh message indicating that its portion of the handshake is finished too.

8. The SSL handshake is now complete and the formal communications session begins, with the client and server using the session key to encrypt, decrypt, and validate the data they exchange. This is the normal operational condition of the secure channel but, at any time, due to internal or external stimulus, either side may renegotiate the connection, in which case, the handshake process is repeated.

There is considerably more to SSL than just described, but the above provides an overview that serves for present purposes and many other references on SSL, CAs, and asymmetric cryptography are publicly available.

Continuing with FIG. 2, the SSL enablement 124 depicted here includes a SSL certificate in storage, suitable processing capability to use it, and both asymmetric and symmetric cryptography to participate in SSL sessions. Although not specifically indicated in FIG. 2, it is to be noted that computerized system 116 has SSL capability. All devices that are suitable for use as the computerized system 116 are SSL capable. For example, the modern Internet browsers in PCs, PDAs, and some cell phones are all inherently SSL capable, and many users of such browsers use SSL on a regular basis.

Accordingly, since the computerized system 116 and the RFID reader 118 in RFID tag security system 100 engage in SSL/TSL sessions across the network link 120, they can communicate via a WiFi network across a room or via the Internet across the world. The use of a SSL/TSL session inherently authenticates the respective end-point systems, permits auditing the transactions that they engage in, and secures the content communicated between them, regardless of whether intervening points are themselves secured. Half of the seamless link 110 is thus secured using SSL/TSL, which is a standardized, well established security protocol that most network administrators concerned with organizational network security today find acceptable. Communications between the RFID reader 118 and the RFID tags 114 across the RF link 122 will be described below.

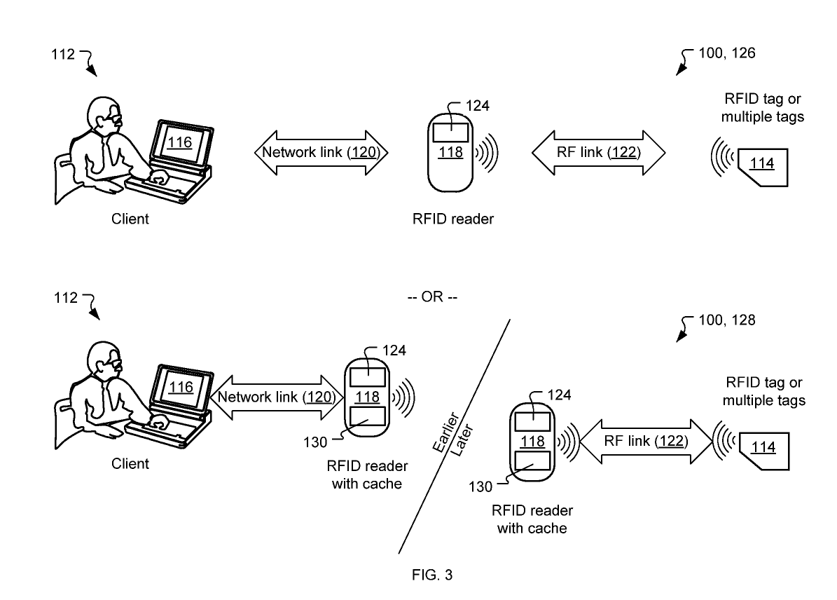

FIG. 3 is a schematic diagram depicting how seamless communications between the client 112 and the RFID tags 114 can follow two basic scenarios 126,128 providing either a literal session or a simulated session, respectively. In an upper-depiction we see scenario 126, where the RFID tag 114 or RFID tags 114 are presently in range of the RFID reader 118, and thus where direct, literal communications with the RFID tags 114 can occur contemporaneously. In contrast, scenario 128 is shown in the lower-depiction in FIG. 3, where the RFID tag 114 or RFID tags 114 not presently in range of the RFID reader 118, and thus where any communications content must be cached. In the latter case a seamless session is simulated, with the actual communications being time-displaced.

An RFID reader 118 will typically not have the memory capacity to hold traffic intended for or received from multiple RFID tags 114. That may be adequate in some simple applications, but, if not, a RFID reader 118 with a dedicated, sizable cache 130 can be used instead. When such a cache 130 is present in the RFID reader 118, the client 112 can transparently store data or commands intended for an RFID tag 114 into the cache 130, or retrieve data from an RFID tag 114 that is already in the cache 130. In particular, the client 112 can do this regardless of whether an intended RFID tag 114 is presently in range of the RFID reader 118. Then, when the RFID tag 114 does come within range of the RFID reader 118, if ever, the RFID reader 118 can “forward” what it has from its cache 130 to that RFID tag 114. Conversely, even when no client 112 is presently in communications with the RFID reader 118, the reader can receive information when a particular RFID tag 114 comes within its range and store this in its cache 130. Then, when communications is established with the client 112, the RFID reader 118 can “forward” what it has from its cache 130 to that client 112.

Providing security in all parts of a seamless end-to-end session between a client 112 and RFID tags 114 is the major remaining issue RFID tag security system 100 has to manage. One very simple way to do this is to use SSL all the way from the computerized system 116 to the RFID tag 114. This approach is within the spirit of the present systems and methods.

Of more practical present interest, because suitable RFID tags for these are presently available and in wide use, are approaches that combine SSL from the computerized system 116 to the RFID reader 118 with another secure protocol from the RFID reader 118 to the RFID tag 114. When “extending” SSL sessions to the RFID tags 114 by using capabilities that they presently have, there should also be an auditable relationship between the two secure protocols used.

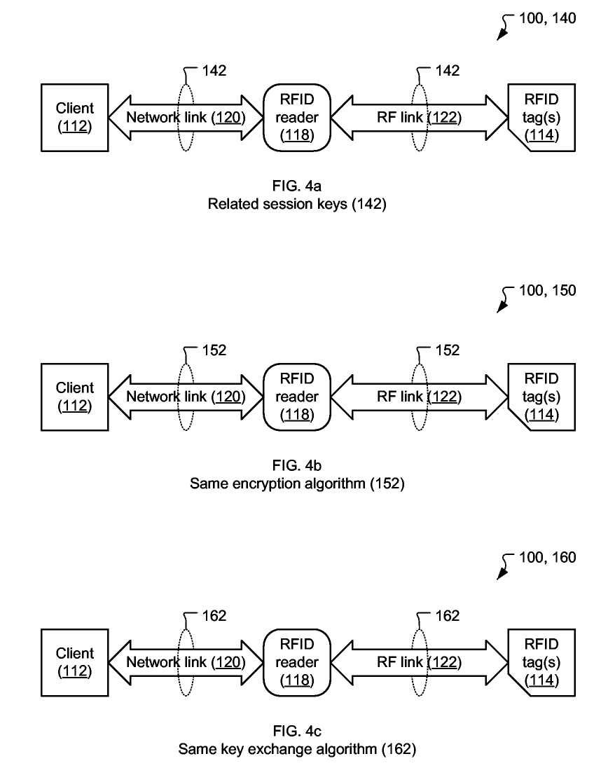

The inventor has devised multiple mechanisms for achieving security in all parts of a seamless end-to-end session between a client 112 and RFID tags 114, as shown in the schematic diagrams in FIG. 4a-c. These mechanisms permit commands and data to not necessarily be decrypted and reencrypted, and for the keys used to only be constructed and stored on the client 112. These mechanisms also allow auditing, if desired. The seamless security of RFID tag security system 100 provides a significant advantage in auditing transactions that pass from the client 112 to the RFID tag 114 and also from the RFID tag 114 to the client 112, via the RFID reader 118. Rather than have two disjoint audit records (client-reader and reader-tag) for each transaction, there now can be one connected audit record.

FIG. 4a depicts a first mechanism 140 using symmetric bulk encryption session keys 142 for both secure protocols (i.e. the client-reader protocol and the reader-tag protocol), with a well known relationship existing between each key 142. The most obvious of these relationships is to use the same key 142 (i.e., one key as the client-reader SSL session key and also as the reader-tag key). In cases where one key 142 is larger than the other, the relationship should be mathematical and not subject to easy collision (i.e., where different larger keys result in the same smaller key), such as a salted hash. This implicitly also requires that the keys 142 be managed in coordination (i.e., that both expire and are renegotiated when either expires).

FIG. 4b depicts a second mechanism 150 using the same symmetric bulk encryption algorithm 152 for both secure protocols (i.e., as the client-reader SSL session protocol and as the reader-tag protocol; e.g., 3DES/TDEA). For instance, if the encryption algorithm 152 is available on the RFID reader 118 via a smart card, both secure protocols can utilize PKCS11 as the encryption algorithm 152 to access the card.

FIG. 4c depicts a third mechanism 160 using a single key exchange algorithm 162 (e.g., D-H or EKE) being used from the computerized system 116 to the RFID tag 114, with the RFID reader 118 acting as a man-in-the-middle to facilitate and log transactions. Here SSL does not have to be used at all, or it could be used for authentication but not for key exchange. The client-reader authentication can also be tied to the reader-tag. For example, D-H, SRP or a similar protocol can be used as an authentication protocol but not as a key exchange protocol. A traditional problem with D-H as a protocol is that man-in-the-middle attacks cannot be detected, but here this vulnerability can be advantageous used to hide the man-in-the-middle (the RFID reader 118) and make the transaction seamless between the client 112 and the RFID tag 114.

The following are examples based on the first mechanism 140 above. The cryptography protocol RC4 uses key lengths of 40-128 bits. For instance Mifare keys are 48 bits and EM 4035 keys are 96 bits. This permits using the same key 142 for all RFID crypto needs in today's RFID systems, without having to hash the symmetric SSL key being used. That is, the crypto capability of the RFID tag 114 itself is still used, but a common or related key 142 is used.

If DES or 3DES is used instead of RC4, the same DES key used to encrypt the data in an SSL session from the computerized system 116 to the RFID reader 118 can be used as the DES or 3DES encryption keys for DESFire type RFID tags 114. One possible problem here is that DESFire specifies that a 3DES key consists of K1, K2, then K1 (a TDEA key composed of K1, K2, K3, but DESFire uses K1 and K2; SSL uses can K1-K3). This makes it so the computerized system 116 has to know this when doing key negotiation.

Consider an example scenario: The client 112 encrypts a command to the RFID reader 118 to write data to the RFID tag 114. The RFID reader 118 thus receives a packet from the computerized system 116, decrypts it, reencrypts it using the same key, and sends it on to the RFID tag 114. One can also decrypt the command but leave the data value encrypted, and then send just the encrypted value onward to the RFID tag 114 unchanged. This saves the processing and security vulnerability involved in performing an unneeded decrypt/reencrypt operation on the data value. This approach allows the client 112 to possess the encryption key without requiring RFID reader 118 transmit the key from RFID reader 118 to client 112.

Another case to consider is that some RFID tags 114 allow passwords to be required to access certain blocks in the RFID tag 114. In the historical context of RFID tags, this is often described as “logging in” to a RFID tag. RFID tag security system 100 can use such a tag password as a password at the client 112, simply using it now for “logging in” at the computerized system 116. For present purposes, this is effectively the same as using keys as described herein. RFID tag security system 100 can also use systems such as Secure Remote Password (SRP) protocol to prevent exposure of the password.

While various embodiments have been described above, it should be understood that they have been presented by way of example only, and that the breadth and scope of the present systems and methods should not be limited by any of the above described exemplary embodiments, but should instead be defined only in accordance with the following claims and their equivalents.

1. A Radio Frequency Identification (RFID) security system, comprising:
a client that includes a computerized system;
at least one RFID tag;
a RFID reader;
wherein:
said computerized system and said RFID reader employ a first security protocol to communicate;
said RFID reader and said RFID tag employ a second security protocol to communicate;
said first security protocol and said second security protocol enable use of at least one member of the set consisting of encryption and authentication, thereby providing security for communications within the RFID security system; and
said first security protocol and said second security protocol both use at least one member of the set consisting of same key exchange algorithms, same encryption algorithms, and related keys, thereby providing seamless communications within the RFID security system.

2. The RFID security system of claim 1, wherein said RFID reader includes a cache to store at least one member of the set consisting of commands for said RFID tag received from said computerized system, data for said RFID tag received from said computerized system, and data for said computerized system received from said RFID tag.

3. The RFID security system of claim 1, wherein at least one of said first security protocol and said second security protocol uses secure sockets layer (SSL)-protocol.

4. The RFID security system of claim 1, wherein said first security protocol and said second security protocol additionally provide auditing of communications within the RFID security system.

5. A method for providing secured communications in a Radio Frequency Identification (RFID) system, between a computerized system and at least one RFID tag, via a RFID reader, the method comprising:
(a) establishing a network link between the computerized system and the RFID reader, wherein said network link employs a first security protocol;
(b) establishing a radio frequency (RF) link between the RFID reader and the RFID tag, wherein said RF link employs a second security protocol, the first security protocol and the second security protocol both using at least one member of a first set consisting of same key exchange algorithms, same encryption algorithms, and related keys; and
(c) communicating, between the computerized system and the RFID tag, at least one member of a second set consisting of commands for the RFID tag from the computerized system, data for the RFID tag from the computerized system, and data for the computerized system from the RFID tag, using the first security protocol and the second security protocol.

6. The method of claim 5, further comprising performing step (a) occur prior to step (b), and caching at least one member of the set consisting of at least one said command for the RFID tag from the computerized system, and an instance of said data for the RFID tag from the computerized system.

7. The method of claim 5, further comprising performing step (b) occur prior to step (a), and caching an instance of said data for the computerized system from the RFID tag.

8. The method of claim 5, wherein at least one of step (a) and step (b) uses secure sockets layer (SSL).

9. The method of claim 5, wherein said first security protocol and said second security protocol use said related keys wherein the relationship between the related keys is that one key is a salted hash of the other key.

10. The method of claim 5, wherein step (c) includes at least one member of a third set consisting of encrypting the second set and authenticating the second set using a member of said first set.

11. The method of claim 5, wherein step (c) includes auditing transactions across at least one of said network link and said RF link.

12. A Radio Frequency Identification (RFID) security system, comprising:
a computerized processing means to process communications within said RFID security system;
at least one RFID tag means for performing at least one member of a first set consisting of receiving and performing a command, receiving and employing an instance of received data, and transmitting an instance of transmitted data;
RFID reader means for engaging in client communications with said computerized processing means with respect to at least one member of said first set;
said RFID reader means further for engaging in tag communications with said at least one RFID tag means with respect to at least one member of said first set;
said computerized processing means and said RFID reader means employing a first security protocol for said client communications;
said RFID reader means and said RFID tag means employing a second security protocol for said tag communications; and
wherein, said first security protocol and said second security protocol permit at least one member of the set consisting of encryption and authentication; and
wherein, said first security protocol and said second security protocol both use at least one member of the set consisting of same key exchange algorithms, same encryption algorithms, and related keys, thereby providing seamless communications within the RFID security system.

13. The RFID security system of claim 12, wherein said RFID reader means includes a cache to store at least one member of the set consisting of said client communications and said tag communications.

14. The RFID security system of claim 12, wherein at least one of said first security protocol and said second security protocol uses secure sockets layer (SSL) protocol.

15. The RFID security system of claim 12, wherein said first security protocol and said second security protocol additionally provide auditing of the communications within the RFID security system.
